(19) United States
(12) Patent Application Publication
(10) Pub. No.: US 2025/0265476 A1
(43) Pub. Date: Aug. 21, 2025

(54) Conditional Finetuning Mechanisms and Data Augmentation for Optimizing the Accuracy of a Platform Performance Predictor

(71) Applicant: MediaTek Inc., Hsinchu City (TW)

(72) Inventors: Ya-Lin Huang, Hsinchu City (TW); Huai-Ting Li, Hsinchu City (TW); I-Lin Chen, Hsinchu City (TW); Yi-Min Tsai, Hsinchu City (TW)

(21) Appl. No.: 18/915,334

(22) Filed: Oct. 14, 2024

Related U.S. Application Data
(60) Provisional application No. 63/555,924, filed on Feb. 21, 2024.

(51) Int. Cl. G06N 3/0985

(52) U.S. Cl. CPC G06N 3/0985

(57) ABSTRACT

A predictor of sub-network performance is conditionally finetuned. The predictor is a neural network that has been trained offline with a general set of neural networks and a general set of hardware and software configurations. The validated performance of a set of sub-networks on a hardware platform is calculated, where the hardware platform is configured with a target setting. Each sub-network is a sub-model of a super-network generated based on a reference deep learning neural network (DNN). Then the predictor calculates predicted performance of the set of sub-networks. The predictor is finetuned in response to a pre-search determination that a difference between the predicted performance and the validated performance exceeds a threshold. The finetuning is based on, at least in part, the reference DNN and the target setting. A network architecture search (NAS) performs in multiple iterations using a same predictor in each iteration and outputs a final network model.

### CROSS-REFERENCE TO RELATED APPLICATIONS

This application claims the benefit of U.S. Provisional Application No. 63/555,924 filed on Feb. 21, 2024, the entirety of which is incorporated by reference herein.

### TECHNICAL FIELD

Embodiments of the invention relate to a performance predictor used in neural architecture search (NAS).

### BACKGROUND OF THE INVENTION

Neural Architecture Search (NAS) can automatically search in a search space for an optimal neural network architecture for a given task. During the search process, each neural network architecture is evaluated (i.e., validated) for its performance on a hardware platform. Based on the validated performance, the search is adjusted to focus on regions of the search space that are more likely to contain promising architectures. This iterative process continues until a stopping criterion is met, and the best-performing neural network architecture is further finetuned before deployment.

To reduce the computing resources required by NAS, a predictor can be used to guide the search process. A predictor can estimate the performance of a given neural network architecture in the NAS search space with less computing cost than a full performance evaluation. One type of predictor is a learning-based predictor, which can be trained to predict the performance of neural network architectures. It is a challenge to balance the need for accuracy and computation cost when training a predictor.

### SUMMARY OF THE INVENTION

In one embodiment, a method is provided for conditionally finetuning a predictor. The method includes calculating validated performance of a set of sub-networks on a hardware platform configured with a target setting. Each sub-network is a sub-model of a super-network that is generated based on a reference deep learning neural network (DNN). The method further includes the predictor calculating predicted performance of the set of sub-networks. The predictor is a neural network that has been trained offline with a general set of neural networks and a general set of hardware and software configurations. The method further includes finetuning the predictor in response to a pre-search determination that a difference between the predicted performance and the validated performance exceeds a threshold. The finetuning is based on, at least in part, the reference DNN and the target setting. The method further includes performing a network architecture search (NAS) in multiple iterations using a same predictor in each iteration, and outputting a final network model after the multiple iterations.

In another embodiment, a system is operative to conditionally finetune a predictor. The predictor is a neural network that has been trained offline with a general set of neural networks and a general set of hardware and software configurations. The system includes a conditional finetuning subsystem and a performance validating subsystem. The conditional finetuning subsystem includes a first set of processors operative to receive a reference DNN, a target setting, and a set of sub-networks. The target setting indicates configurations for optimizing neural network operations and configurations for hardware usage. Each sub-network is a sub-model of a super-network that is generated based on the reference DNN. The conditional finetuning subsystem is further operative to request the performance validating subsystem for validated performance of the set of sub-networks on a hardware platform configured with the target setting. The conditional finetuning subsystem uses the predictor to calculate predicted performance of the set of sub-networks, and finetune the predictor in response to a determination that a difference between the predicted performance and the validated performance exceeds a threshold. The finetuning is based on, at least in part, the reference DNN and the target setting. The performance validating subsystem includes a second set of processors operative to calculate the validated performance of the set of sub-networks by the hardware platform configured with the target setting or a simulator of the hardware platform. The performance validating subsystem is in an isolated environment that protects information of the hardware platform from unauthorized access.

In yet another embodiment, a method is provided for conditionally finetuning a predictor. The method includes performing a first network architecture search (NAS) in multiple iterations in a search space of sub-networks using the predictor that stays the same throughout the multiple iterations. Each sub-network is a sub-model of a super-network that is generated based on a reference DNN. The predictor is a neural network that has been trained offline with a general set of neural networks and a general set of hardware and software configurations. The method further includes calculating validated performance of sampled sub-networks on a hardware platform configured with a target setting. The method further includes the predictor calculating predicted performance of the sampled sub-networks. In response to a post-search determination that a difference between the predicted performance and the validated performance exceeds a threshold, the predictor is finetuned and a second NAS is performed with the finetuned predictor. The finetuning is based on, at least in part, the reference DNN and the target setting. One of the first NAS and the second NAS outputs a final network model.

Other aspects and features will become apparent to those ordinarily skilled in the art upon review of the following description of specific embodiments in conjunction with the accompanying figures.

### BRIEF DESCRIPTION OF DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a block diagram illustrating an overall view of a conditional finetuning process for a predictor according to a first embodiment.

FIG. 2 is a block diagram illustrating a process for conditionally finetuning a predictor according to the first embodiment.

FIG. 3 is a block diagram illustrating an overall view of a conditional finetuning process for a predictor according to a second embodiment.

FIG. 4 is a block diagram illustrating a process for conditionally finetuning a predictor according to the second embodiment.

FIG. 5 is a block diagram illustrating a process for conditionally finetuning a predictor according to a third embodiment.

FIG. 6 is a diagram illustrating a system performing conditional finetuning of a predictor according to one embodiment.

FIG. 7 is a flow diagram illustrating a method for conditionally finetuning a predictor according to one embodiment.

FIG. 8 is a flow diagram illustrating a method for conditionally finetuning a predictor according to another embodiment.

FIG. 9 is a flow diagram illustrating a method for conditionally finetuning a predictor according to yet another embodiment.

### DETAILED DESCRIPTION OF THE INVENTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The disclosure herein describes a platform performance predictor (also referred to as a “predictor”) that is conditionally finetuned to improve prediction accuracy. The predictor is a neural network, which is trained offline and conditionally finetuned online. Non-limiting examples of the predictor include a deep neural network (DNN), a graphic convolutional network (GCN), a transformer network, and other types of neural networks. The predictor receives input features and generates predicted performance metrics such as latency, power, memory access, etc. The input features may be operation-based, model-based, instruction-based, etc. Non-limiting examples of the operation-based features include TensorFlow Application Programming Interface (API), PyTorch API, etc.; model-based features include graphs, mathematical descriptions, etc.; and instruction-based features include hardware-specific instructions.

The conditional finetuning mechanism combines the benefits of both offline training and online training. Purely offline-trained predictors have low accuracy for architectures and platform settings that are not in the training dataset. Purely online training slows down the speed of network search and requires validations for each round of retraining. The conditional finetuning significantly reduces the validation time compared to online training during a NAS process and improves the accuracy of offline training. The predictor is finetuned to the target setting of the hardware platform and software configurations. The finetuning labels are the performance metrics (e.g., latency, power, memory access) of the finetuning data using the target compile optimizations and hardware settings. The predictor is first trained offline, and is finetuned only when the predicted performance is unacceptable compared to the validated performance. The composition of the finetuning data, as will be described later, can prevent the predictor from overfitting after being finetuned.

In the following description, the term “validate” (e.g., when used in “validating a sub-network”) means that the performance of the sub-network is evaluated (i.e., validated) by running the operations of the sub-network on a hardware platform with a given setting or a simulator of the hardware platform. The term “validated performance” means that the performance of a neural network executed on a hardware platform is evaluated with respect to one or more performance metrics, such as latency, power, memory bandwidth. The evaluation (also referred to as “validation”) may be performed by the hardware platform or a hardware simulator. The term “predicted performance” means that a predictor predicts the performance of a neural network executed on a hardware platform without actually running the neural network operations on hardware or a hardware simulator. The term “predicted performance is acceptable” means that the predictor has a high level of accuracy, which may be indicated by the difference between the predicted performance and the validated performance being within a threshold. The predicted performance is unacceptable when the difference exceeds the threshold. The difference can be measured by one or more performance metrics. Furthermore, the terms “network search”, “network architecture search (NAS)”, and “search operations” may be used interchangeably throughout the disclosure.

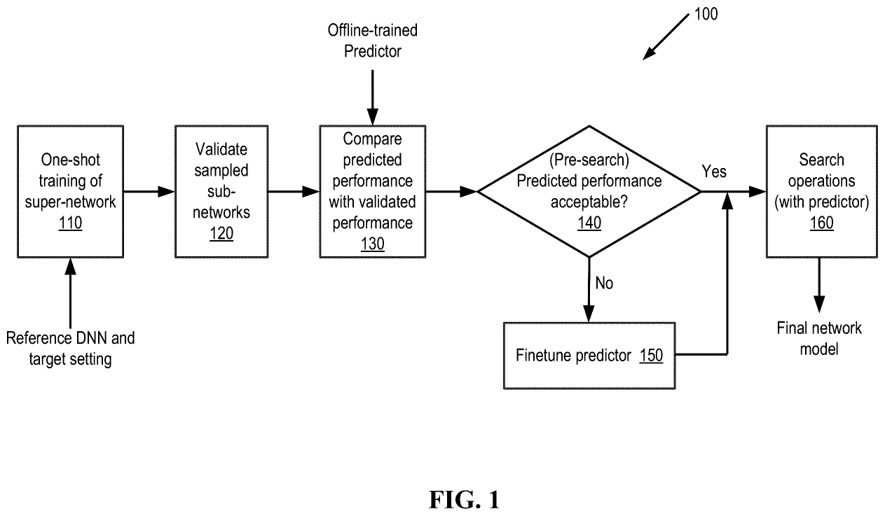

FIG. 1 is a block diagram illustrating an overall view of a conditional finetuning process 100 for a predictor according to a first embodiment. The predictor is initially trained offline. A client (e.g., a user) provides a reference deep learning neural network (DNN) and a target setting, both of which are specific to the client's usage scenario. The reference DNN specifies the neural network operations that the client is intended for a hardware platform to execute. The target setting may include configurations for optimizing neural network operations and hardware usage. For example, optimization of neural network operations may include model tiling for parallelization, layer fusion, etc. Optimization of hardware usage may include optimized memory bandwidth (e.g., dynamic random-access memory (DRAM) bandwidth), optimized dynamic voltage and frequency scaling (DVFS), etc. A super-network is generated from the reference DNN as a collection of variations of the reference DNN. In one embodiment, the super-network may be generated by incorporating architectural, parametric, and/or operational variations of the reference DNN. The super-network can be represented by a directed acyclic graph (DAG) whose subgraphs represent different candidate neural networks. At step 110, the entire super-network is trained; such training is called one-shot training. The super-network may also be referred to as a super-net, a supergraph, or a one-shot model. Subgraphs of the super-network may be referred to as sub-networks or sub-models. With one-shot training of the super-network, the sub-networks do not need to be separately trained.

In the first embodiment, after the one-shot training of the super-network, at step 120, sub-networks are sampled from an initial population (e.g., the first generation) of sub-networks, and the sampled sub-networks are validated. At step 130, the validated performance is compared with predicted performance generated by the offline-trained predictor. This comparison is also referred to as the pre-search predictor accuracy check. At step 140, it is determined, based on the result of the comparison, whether or not the predicted performance is acceptable. If the predicted performance is not acceptable, the predictor is finetuned at step 150 and then the process 100 proceeds to step 160. If the predicted performance is acceptable, the finetuning step 150 is bypassed and the process 100 proceeds to step 160. At step 160, search operations are performed with the offline-trained or finetuned predictor according to a NAS algorithm, such as a reinforcement learning algorithm, an evolutionary algorithm, a Bayesian optimization algorithm, a gradient-based optimization algorithm, or the like. More details on NAS algorithms can be found in Elsken et al. Neural architecture search: A survey. Journal of Machine Learning Research 20.55 (2019): 1-21. The output of the search operations is a final network model, which may be finetuned to produce a final output.

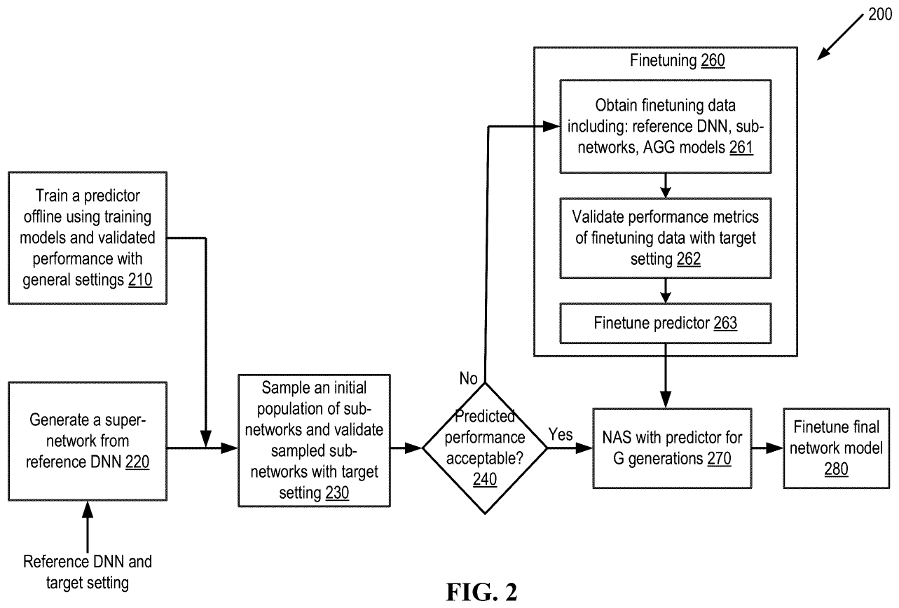

FIG. 2 is a block diagram illustrating a process 200 for conditionally finetuning a predictor according to the first embodiment in further detail. Initially, at step 210, a predictor is trained offline using a general set of neural networks and validated performance of the neural networks, where the validated performance is generated by hardware or a simulator of the hardware configured with a general set of hardware and software configurations. A “general set” is designed to be comprehensive without targeting any specific features possessed by the members in the set. The training models include a collection of neural networks with different architectures and hyperparameters. The predictor is used by NAS in selecting a network architecture predicted to have optimal performance. At step 220, a super-network is generated from a reference DNN. At step 230, an initial population of sub-networks are sampled and validated. That is, for each sampled sub-network, one or more performance metrics of running the sub-network on a hardware platform with the target setting are evaluated. The evaluation may be performed by the hardware platform or a simulator of the hardware platform. At step 240, the predicted performance of each sampled sub-network is compared with the corresponding validated performance. If, at step 240, it is determined that the predicted performance is acceptable, the predictor does not need finetuning and the process 200 proceeds to step 270 at which a network search is performed with the predictor for multiple iterations until an ending criterion is met. In one embodiment, the network search uses a NAS algorithm in which the population of sub-networks is updated in each iteration (i.e., generation). The search may produce G generations, where G may be on the order of hundreds. If the predicted performance is unacceptable, the process 200 proceeds to a finetuning step 260 at which the predictor is finetuned.

In one embodiment, at step 261, the finetuning data includes the reference DNN, the sub-networks sampled at step 230, and auto-generated graph (AGG) models. These networks and models are processed into a predefined feature format to serve as the input for a predictor model. The AGG models augment the reference DNN and the sampled sub-networks by incorporating predefined architectures, and by alternating among similar operations and various structural parameters. For example, the predefined architectures may include architectures for super-resolution models, architectures of transformers, etc. Non-limiting examples of operations that are similar to convolution include depth-wise convolution, transpose convolution, and depth-to-space operations, etc. Non-limiting examples of structural parameters include input height H, input width W, input channel number Cin, output channel number Cout, kernel size K, stride S, etc. The composition of the finetuning data avoids predictor overfitting.

At step 262, all of the finetuning data is validated by hardware or a simulator of the hardware configured with the target setting. That is, all of the finetuning data is labeled with performance metrics. At step 263, the predictor is finetuned using the validated finetuning data, and the process 200 proceeds to step 270 at which a network architecture search is performed with the predictor for multiple iterations (e.g., for G generations) until an ending criterion is met. The output of the NAS is a final network model, which may be finetuned at step 280 to produce a final output.

It is noted that when the predictor is trained offline, the training does not take into account the client's reference DNN and the target setting. The offline training may start with randomly-initiated training models. The training labels (e.g., performance metrics) of the training models may be generated with randomly-initiated software and hardware configurations. By contrast, the finetuning data is generated based on the reference DNN, and the training labels of the finetuning data is generated based on the target setting. That is, the predictor is finetuned to the target platform setting, and the training labels are generated using the target compile-optimization and hardware usage configurations specified in the target setting. Thus, the finetuning can improve and enhance the accuracy of a predictor for use in a network search that comes with a given reference model and a target setting.

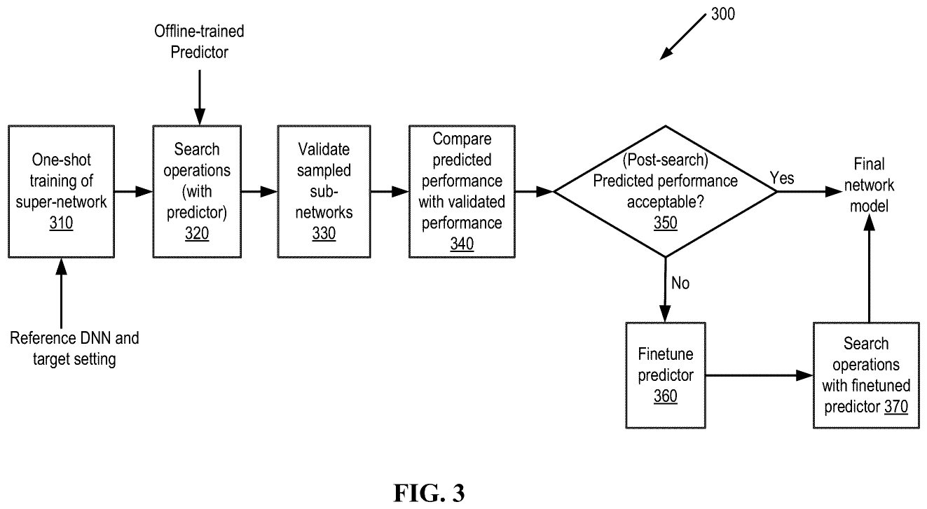

FIG. 3 is a block diagram illustrating an overall view of a conditional finetuning process 300 for a predictor according to a second embodiment. In the second embodiment, step 310 is the same as step 110 in FIG. 1 at which a super-network is generated and trained. At step 320, the search operations, guided by an offline-trained predictor, are performed on sub-networks sampled from multiple generations of sub-networks, where each sub-network is a sub-model of the super-network. At step 330, the performance of each sampled sub-network is evaluated (i.e., validated) by hardware with the target setting or a simulator of the hardware. At step 340, the validated performance is compared with predicted performance generated by the offline-trained predictor. This comparison is also referred to as the post-search predictor accuracy check. At step 350, it is determined, based on the result of the comparison, whether or not the predicted performance is acceptable. If the comparison result indicates that predicted performance is unacceptable, the predictor is finetuned at step 360 and the process 300 proceeds to step 370. At step 370, the search operations are re-run with the finetuned predictor according to any of the aforementioned NAS algorithms to produce a final network model, which may be finetuned to produce a final output. If the predicted performance is acceptable, the finetuning step 360 is bypassed and the process 300 proceeds to output a final network model, which may be finetuned to produce a final output.

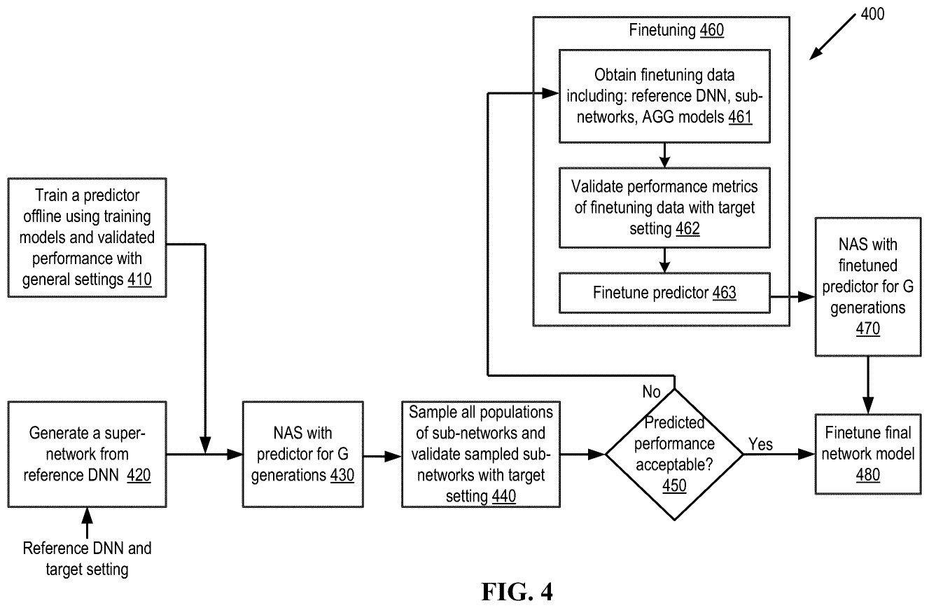

FIG. 4 is a block diagram illustrating a process 400 for conditionally finetuning a predictor according to the second embodiment in further detail. The description of offline training of the predictor at step 410 is the same as step 210 in FIG. 2 and is, therefore, not repeated. At step 420, a super-network is generated from variations of the reference DNN. At step 430, a network search is performed on sub-networks of the super-network using the predictor for multiple iterations (e.g., G generations). At step 440, sub-networks of all populations of the G generations are sampled and validated by hardware or a simulator of the hardware with the target setting. At step 450, the predicted performance of each sampled sub-network is compared with the corresponding validated performance. If, at step 450, it is determined that the predicted performance is acceptable, the predictor does not need finetuning and the process 400 proceeds to output a final network model, which may be further finetuned at step 480. If the predicted performance is unacceptable, the process 400 proceeds to a finetuning step 460 at which the predictor is finetuned. The description of finetuning step 460 is the same as finetuning step 260 in FIG. 2 and is, therefore, not repeated. The finetuned predictor is used at step 470 to guide a re-run of the network search for multiple iterations until an ending criterion is met (e.g., for G generations). The output of the network search is a final network model, which may be further finetuned at step 480.

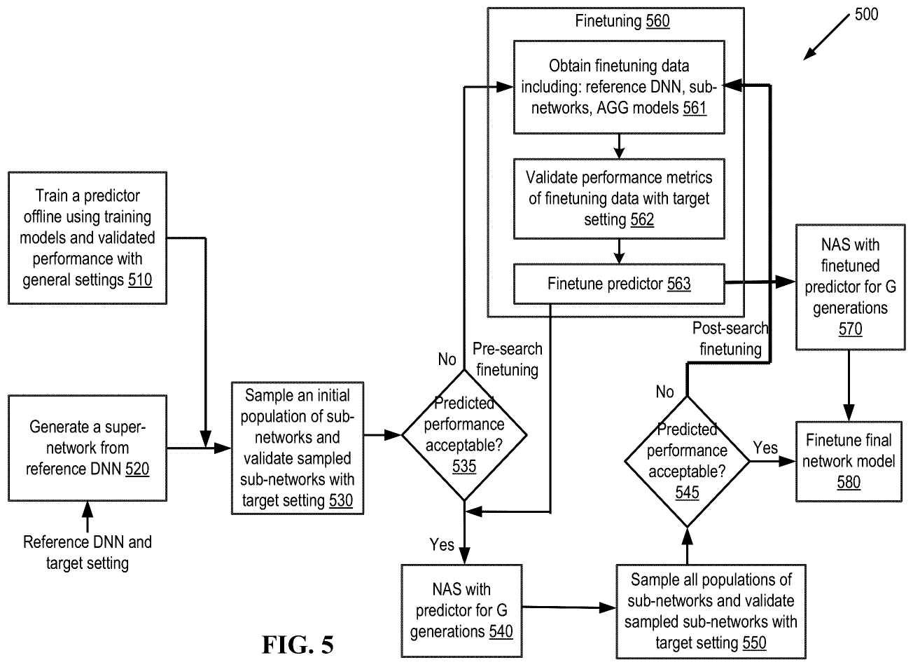

The first embodiment and the second embodiment may be combined such that the predictor accuracy is checked both before and after a network search. FIG. 5 is a block diagram illustrating a process 500 for conditionally finetuning a predictor according to a third embodiment. The description of steps 510, 520, and 530 is the same as steps 210, 220, and 230 in FIG. 2, respectively, and is, therefore, not repeated.

Referring to FIG. 5, at step 535, the pre-search predictor accuracy check is performed by comparing the predicted performance of each sampled sub-network with the corresponding validated performance. If the predicted performance is acceptable, the predictor does not need finetuning and the process 500 proceeds to step 540. If the predicted performance is unacceptable, the process 500 proceeds to a finetuning step 560 at which the predictor is finetuned and continues to step 540. The description of finetuning step 560 is the same as finetuning step 260 in FIG. 2 and is, therefore, not repeated.

At step 540, a network search is performed with the predictor for multiple iterations until an ending criterion is met (e.g., for G generations). At step 550, sub-networks of all populations of the G generations are sampled and validated. The process 500 proceeds to step 545 for the post-search predictor accuracy check. If the predicted performance is acceptable, the predictor does not need finetuning and the process 500 proceeds to output a final network model, which may be further finetuned at step 580. If the predicted performance is unacceptable, the process 500 proceeds to the finetuning step 560 at which the predictor is finetuned. The finetuned predictor is used at step 570 to guide a re-run of the network search for multiple iterations until an ending criterion is met (e.g., for G generations). The output of the network search is a final network model, which may be further finetuned at step 580.

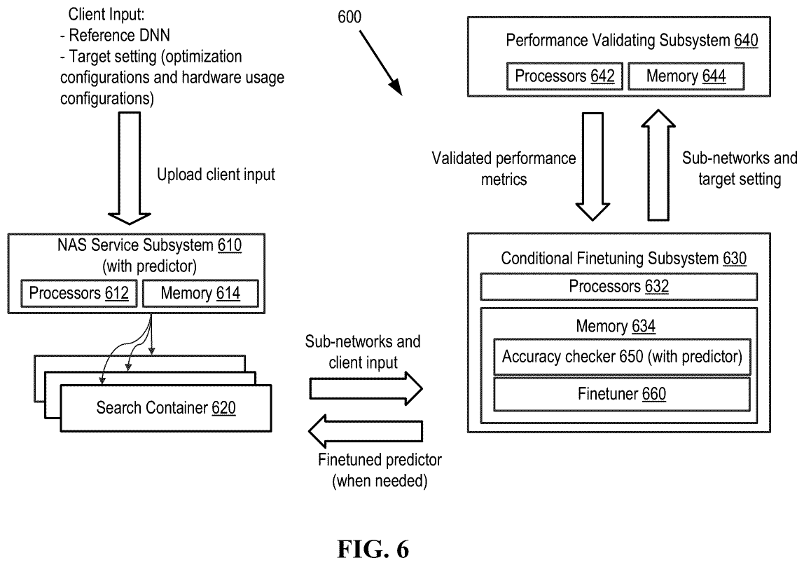

FIG. 6 is a diagram illustrating a system 600 performing conditional finetuning of a predictor according to one embodiment. FIG. 6 provides an example scenario in which any of the conditional finetuning shown in FIG. 1-FIG. 5 may be performed. The system 600 includes a NAS service subsystem 610, a conditional finetuning subsystem 630, and a performance validating subsystem 640. A client provides input to the NAS service subsystem 610 to request a search for a network architecture. The client input may include a reference architecture such as a reference DNN, and a target setting specifying optimization configurations for neural network operations and hardware usage configurations. The NAS service subsystem 610 includes processors 612 and memory 614. The NAS service subsystem 610 may provide multiple search containers 620, each of which provides a software environment for a different network search request. The NAS service subsystem 610 generates a super-network based on the reference DNN and trains the super-network. The NAS service subsystem 610 performs a network search in multiple iterations in a search space using a predictor that stays the same throughout the multiple iterations. The search space includes a set of sub-networks, which are sub-models of the super-network. The predictor is a neural network that has been trained offline with a general set of neural networks and a general set of hardware and software configurations. To determine whether the predictor should be finetuned, the NAS service subsystem 610 sends sampled sub-networks and the client input to the conditional finetuning subsystem 630, requesting the conditional finetuning subsystem 630 to perform an accuracy check on the predictor and finetune the predictor if necessary.

The conditional finetuning subsystem 630 includes processors 632 coupled to a memory 634. The processors 632 are operative to execute the instructions of an accuracy checker 650 and a finetuner 660 that are stored in the memory 634. The accuracy checker 650 receives the reference DNN, the target setting, and the sub-networks from the NAS service subsystem 610, and then requests the performance validating subsystem 640 for validated performance of the sub-networks on a hardware platform configured with the target setting. The accuracy checker 650 has access to the offline-trained predictor. The accuracy checker 650 uses the predictor to calculate predicted performance of the sub-networks, and compares the predicted performance with the validated performance from the performance validating subsystem 640. If the predicted performance is unacceptable (e.g., the difference between the predicted performance and the validated performance exceeds a threshold), the accuracy checker 650 uses the finetuner 660 to finetune the predictor. The finetuning may be based on, at least in part, the reference DNN and the target setting. The finetuning may be performed according to operations described at step 260 (FIG. 2), step 460 (FIG. 4), or step 560 (FIG. 5). The finetuned predictor is sent to the NAS service subsystem 610 to guide the search operations. If the predicted performance is acceptable, the conditional finetuning subsystem 630 indicates to the NAS service subsystem 610 that no finetuning is needed for the predictor.

The performance validating subsystem 640 includes processors 642 coupled to a memory 644. The processors 642 may include central processing units (CPUs), graphics processing units (GPUs), artificial intelligence (AI) processors, digital signal processors, and other general-purpose and/or special-purpose processing circuitry. One or more of the processors 642 provides a hardware platform for executing neural network operations. The hardware platform configured with the target setting can validate the performance of sub-networks. The validated performance may be indicated by one or more aforementioned performance metrics. In one embodiment, the memory 644 stores instructions, which, when executed by the processors 642, perform the operations of a simulator, which simulates the hardware platform that executes neural network operations. The simulator output is one or more validated performance metrics of the neural network execution. The validated performance metrics are sent back to the conditional finetuning subsystem 630.

The separation of the computing nodes for the NAS service subsystem 610, the conditional finetuning subsystem 630, and the performance validating subsystem 640 protects intellectual property (IP) rights of software and hardware designs. The performance validating subsystem 640 may be in an isolated environment that protects information of the hardware platform from unauthorized access, e.g., only those entities authorized by the hardware manufacturer can gain access to the hardware platform that executes the operations of the sub-networks. In some scenarios, the NAS service subsystem 610 may be a service platform that runs on the user's local node or in a cloud computing environment provided by the hardware manufacturer. The conditional finetuning subsystem 630 may be hosted by the cloud computing environment of the hardware manufacturer.

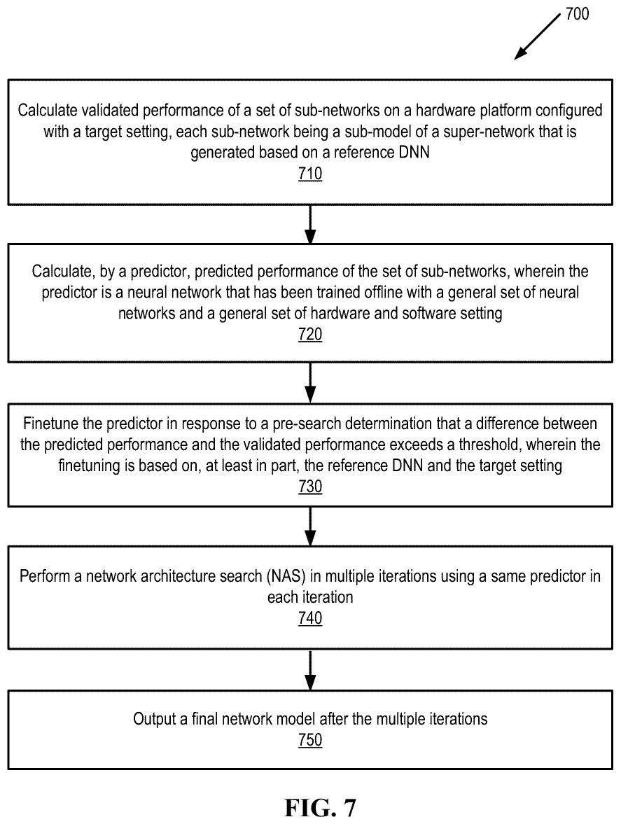

FIG. 7 is a flow diagram illustrating a method 700 for conditionally finetuning a predictor according to one embodiment, e.g., the first embodiment shown in FIG. 1 and FIG. 2. The method 700 may be performed by a system such as the system 600 in FIG. 6, or another computing system. The predictor is a neural network that has been trained offline with a general set of neural networks and a general set of hardware and software configurations. In one embodiment, the method 700 starts with step 710 in which a system calculates validated performance of a set of sub-networks on a hardware platform that is configured with a target setting. Each sub-network is a sub-model of a super-network that is generated based on a reference DNN. At step 720, the predictor calculates predicted performance of the set of sub-networks. At step 730, the system finetunes the predictor in response to a pre-search determination that a difference between the predicted performance and the validated performance exceeds a threshold. The finetuning is based on, at least in part, the reference DNN and the target setting. At step 740, the system performs a network architecture search (NAS) in multiple iterations using the same predictor in each iteration. At step 750, the system outputs a final network model after the multiple iterations.

The pre-search predictor finetuning described in connection with FIG. 7 may be expanded to additionally include post-search finetuning. In one embodiment, after the multiple iterations of the NAS, the system calculates a second validated performance and a second predicted performance of a second set of sub-networks. In response to a post-search determination that a second difference between the second predicted performance and the second validated performance exceeds a second threshold, the system finetunes the predictor and performs a second NAS with the finetuned predictor. The system then outputs the final network model from one of the NAS and the second NAS. In one embodiment, the set of sub-networks is sampled from an initial population of sub-networks on which the NAS is performed. The initial population is updated in each iteration of the NAS to form a new population. The second set of sub-networks is sampled from all populations of the multiple iterations.

In one embodiment, the system bypasses the finetuning of the predictor when the pre-search determination indicates that the difference between the predicted performance and the validated performance does not exceed the threshold. In one embodiment, each of the predicted performance and the validated performance is indicated by one or more performance metrics of running a given neural network on the hardware platform. The performance metrics include latency, power, and memory access. In one embodiment, the target setting includes configurations for optimizing neural network operations and configurations for hardware usage.

In one embodiment, to finetune the predictor, the system obtains finetuning data including the reference DNN, the set of sub-networks, and auto-generated augmented (AGG) models. The AGG models include neural networks that are generated using predefined neural network architectures, variations of neural network operations, and variations of neural network structural parameters. The system validates the finetuning data using the hardware platform configured with the target setting or the simulator of the hardware platform.

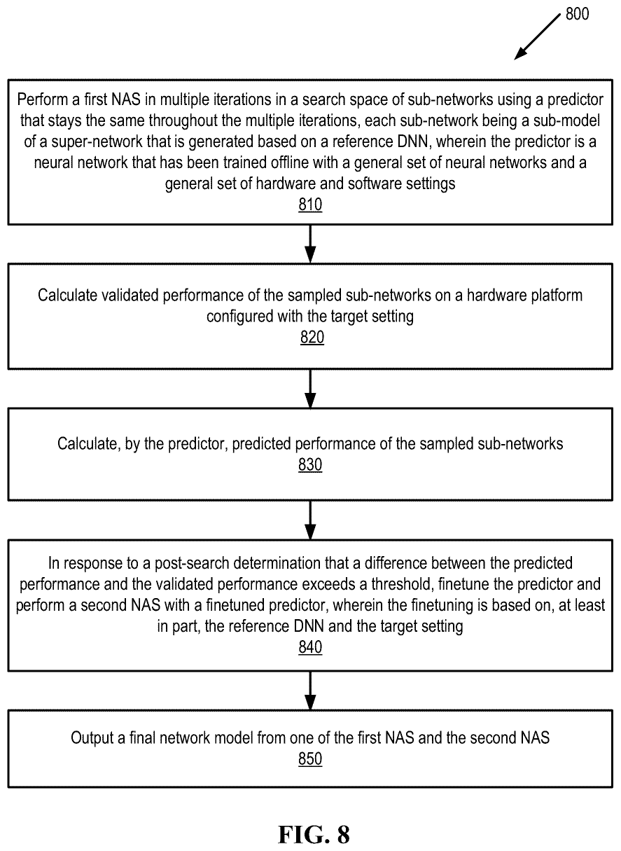

FIG. 8 is a flow diagram illustrating a method 800 for conditionally finetuning a predictor according to another embodiment, e.g., the second embodiment shown in FIG. 3 and FIG. 4. The method 800 may be performed by a system such as the system 600 in FIG. 6, or another computing system. The predictor is a neural network that has been trained offline with a general set of neural networks and a general set of hardware and software configurations. In one embodiment, the method 800 starts with step 810 in which a system performs a first NAS in multiple iterations in a search space of sub-networks using the predictor that stays the same throughout the multiple iterations. Each sub-network is a sub-model of a super-network that is generated based on a reference DNN. At step 820, the system calculates validated performance of sampled sub-networks on a hardware platform configured with a target setting. At step 830, the predictor calculates predicted performance of the sampled sub-networks. At step 840, in response to a post-search determination that a difference between the predicted performance and the validated performance exceeds a threshold, the system finetunes the predictor and performs a second NAS with a finetuned predictor. The finetuning is based on, at least in part, the reference DNN and the target setting. At step 850, the system outputs a final network model from one of the first NAS and the second NAS (i.e., from the first NAS or the second NAS).

In one embodiment, the system bypasses the finetuning of the predictor when the post-search determination indicates that the difference between the predicted performance and the validated performance does not exceed the threshold.

The post-search predictor finetuning described in connection with FIG. 8 may be expanded to additionally include pre-search finetuning. In one embodiment, prior to performing the first NAS, the system calculates a first validated performance of a first set of sub-networks on the hardware platform configured with the target setting. The predictor calculates a first predicted performance of the first set of sub-networks. The system finetunes the predictor in response to a pre-search determination that a first difference between the first predicted performance and the first validated performance exceeds a first threshold.

In one embodiment, the first set of sub-networks is sampled from an initial population of sub-networks on which the first NAS is performed. The initial population is updated in each iteration of the first NAS to form a new population. The sampled sub-networks for calculating the predicted performance and the validated performance are sampled from all populations of the multiple iterations.

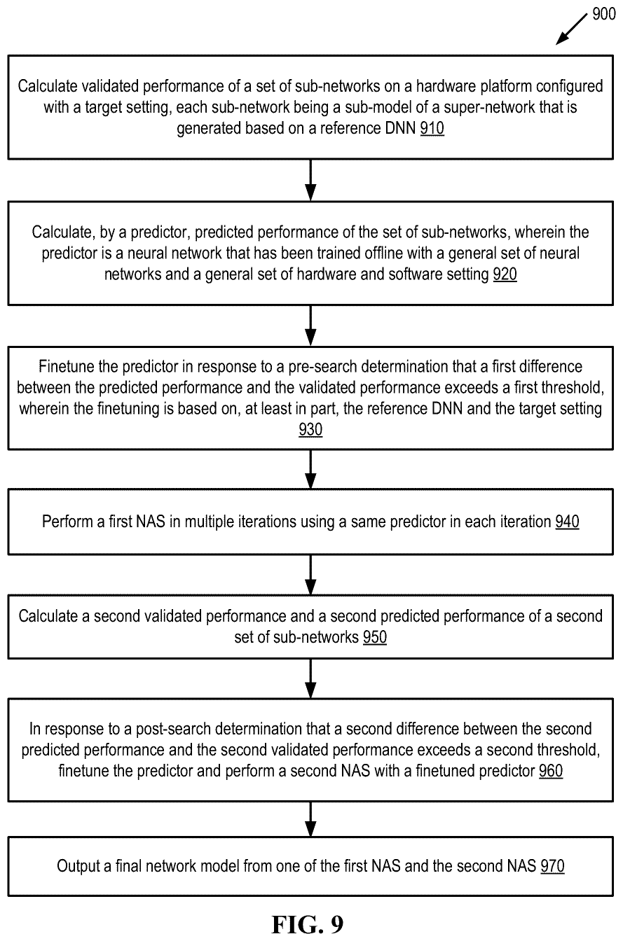

FIG. 9 is a flow diagram illustrating a method 900 for conditionally finetuning a predictor according to yet another embodiment, e.g., the third embodiment shown in FIG. 5. The method 900 may be performed by a system such as the system 600 in FIG. 6, or another computing system. The predictor is a neural network that has been trained offline with a general set of neural networks and a general set of hardware and software configurations. In one embodiment, the method 900 starts with step 910 in which a system calculates validated performance of a set of sub-networks on a hardware platform configured with a target setting. Each sub-network is a sub-model of a super-network that is generated based on a reference DNN. At step 920, the predictor calculates predicted performance of the set of sub-networks. At step 930, the system finetunes the predictor in response to a pre-search determination that a first difference between the predicted performance and the validated performance exceeds a first threshold. The finetuning is based on, at least in part, the reference DNN and the target setting. At step 940, the system performs a first NAS in multiple iterations using the same predictor in each iteration. The system at step 950 calculates a second validated performance and a second predicted performance of a second set of sub-networks. In response to a post-search determination that a second difference between the second predicted performance and the second validated performance exceeds a second threshold, the system at step 960 finetunes the predictor and performs a second NAS with a finetuned predictor. The system at step 970 outputs a final network model from one of the first NAS and the second NAS (i.e., the first NAS or the second NAS).

The operations of the flow diagrams of FIG. 7-FIG. 9 have been described with reference to the exemplary embodiment of FIG. 6. However, it should be understood that the operations of the flow diagrams of FIG. 7-FIG. 9 can be performed by embodiments of the invention other than the embodiment of FIG. 6, and the embodiment of FIG. 6 can perform operations different than those discussed with reference to the flow diagrams. It is understood that the order of operations shown in the flow diagrams of FIG. 7-FIG. 9 is a non-limiting example. Alternative embodiments may perform the operations in a different order, combine certain operations, overlap certain operations, etc.

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for conditionally finetuning a predictor, comprising:
calculating validated performance of a set of sub-networks on a hardware platform configured with a target setting, each sub-network being a sub-model of a super-network that is generated based on a reference deep learning neural network (DNN);
calculating, by the predictor, predicted performance of the set of sub-networks, wherein the predictor is a neural network that has been trained offline with a general set of neural networks and a general set of hardware and software configurations;
finetuning the predictor in response to a pre-search determination that a difference between the predicted performance and the validated performance exceeds a threshold, wherein the finetuning is based on, at least in part, the reference DNN and the target setting;
performing a network architecture search (NAS) in multiple iterations using a same predictor in each iteration; and
outputting a final network model after the multiple iterations.

2. The method of claim 1, wherein, after the multiple iterations of the NAS, the method further comprises:
calculating a second validated performance and a second predicted performance of a second set of sub-networks;
in response to a post-search determination that a second difference between the second predicted performance and the second validated performance exceeds a second threshold, finetuning the predictor and performing a second NAS with a finetuned predictor; and
outputting the final network model from one of the NAS and the second NAS.

3. The method of claim 2, wherein the set of sub-networks is sampled from an initial population of sub-networks on which the NAS is performed, wherein the initial population is updated in each iteration of the NAS to form a new population, and the second set of sub-networks is sampled from all populations of the multiple iterations.

4. The method of claim 1, further comprising:
bypassing the finetuning of the predictor when the pre-search determination indicates that the difference between the predicted performance and the validated performance does not exceed the threshold.

5. The method of claim 1, wherein the finetuning the predictor further comprises:
obtaining finetuning data including the reference DNN, the set of sub-networks, and auto-generated augmented (AGG) models, wherein the AGG models includes neural networks that are generated using predefined neural network architectures, variations of neural network operations, and variations of neural network structural parameters; and
validating the finetuning data using the hardware platform configured with the target setting or the simulator of the hardware platform.

6. The method of claim 1, wherein each of the predicted performance and the validated performance is indicated by one or more performance metrics of running a given neural network on the hardware platform, the performance metrics including latency, power, and memory access.

7. The method of claim 1, wherein the target setting includes configurations for optimizing neural network operations and configurations for hardware usage.

8. A method for conditionally finetuning a predictor, comprising:
performing a first network architecture search (NAS) in multiple iterations in a search space of sub-networks using the predictor that stays the same throughout the multiple iterations, each sub-network being a sub-model of a super-network that is generated based on a reference deep learning neural network (DNN), wherein the predictor is a neural network that has been trained offline with a general set of neural networks and a general set of hardware and software configurations;
calculating validated performance of sampled sub-networks on a hardware platform configured with a target setting;
calculating, by the predictor, predicted performance of the sampled sub-networks;
in response to a post-search determination that a difference between the predicted performance and the validated performance exceeds a threshold, finetuning the predictor and performing a second NAS with a finetuned predictor, wherein the finetuning is based on, at least in part, the reference DNN and the target setting; and
outputting a final network model from one of the first NAS and the second NAS.

9. The method of claim 8, wherein, prior to performing the first NAS, the method further comprises:
calculating a first validated performance of a first set of sub-networks on the hardware platform configured with the target setting;
calculating, by the predictor, a first predicted performance of the first set of sub-networks; and
finetuning the predictor in response to a pre-search determination that a first difference between the first predicted performance and the first validated performance exceeds a first threshold.

10. The method of claim 9, wherein the first set of sub-networks is sampled from an initial population of sub-networks on which the first NAS is performed, the initial population being updated in each iteration of the first NAS to form a new population, and the sampled sub-networks for calculating the predicted performance and the validated performance are sampled from all populations of the multiple iterations.

11. The method of claim 8, further comprising:
bypassing the finetuning of the predictor when the post-search determination indicates that the difference between the predicted performance and the validated performance does not exceed the threshold.

12. The method of claim 8, wherein the finetuning the predictor further comprises:
obtaining finetuning data including the reference DNN, the sampled sub-networks, and auto-generated augmented (AGG) models, where the AGG models includes neural networks that are generated using predefined neural network architectures, variations of neural network operations, and variations of neural network structural parameters; and
validating the finetuning data using the hardware platform configured with the target setting or a simulator of the hardware platform.

13. The method of claim 8, wherein each of the predicted performance and the validated performance is indicated by one or more performance metrics of running a given neural network on the hardware platform, the performance metrics including latency, power, and memory access.

14. The method of claim 8, wherein the target setting includes configurations for optimizing neural network operations and configurations for hardware usage.

15. A system for conditional finetuning a predictor, the predictor being a neural network that has been trained offline with a general set of neural networks and a general set of hardware and software configurations, the system comprising:
a conditional finetuning subsystem including a first set of processors operative to:
receive a reference deep learning neural network (DNN), a target setting, and a set of sub-networks, wherein the target setting indicates configurations for optimizing neural network operations and configurations for hardware usage, and wherein each sub-network is a sub-model of a super-network that is generated based on the reference DNN;
request a performance validating subsystem for validated performance of the set of sub-networks on a hardware platform configured with the target setting;
calculate, by the predictor, predicted performance of the set of sub-networks; and
finetune the predictor in response to a determination that a difference between the predicted performance and the validated performance exceeds a threshold, wherein the finetuning is based on, at least in part, the reference DNN and the target setting; and
the performance validating subsystem including a second set of processors operative to:
calculate the validated performance of the set of sub-networks by the hardware platform configured with the target setting or a simulator of the hardware platform,
wherein the performance validating subsystem is in an isolated environment that protects information of the hardware platform from unauthorized access.

16. The system of claim 15, wherein the conditional finetuning subsystem is further operative to:
obtain finetuning data including the reference DNN, sampled sub-networks, and auto-generated augmented (AGG) models, where the AGG models includes neural networks that are generated using predefined neural network architectures, variations of neural network operations, and variations of neural network structural parameters; and
request the performance validating subsystem to validate the finetuning data using the hardware platform configured with the target setting or a simulator of the hardware platform.

17. The system of claim 15, further comprising:
a network architecture search (NAS) service subsystem including a third set of processors operative to:
receive an input including the reference DNN and the target setting;
perform a NAS in multiple iterations in a search space including the set of sub-networks using the predictor that stays the same throughout the multiple iterations; and
request the conditional finetuning subsystem to perform an accuracy check on the predictor and finetune the predictor based on the accuracy check.

18. The system of claim 17, wherein the NAS service subsystem is further operative to request the conditional finetuning subsystem for the accuracy check before performing the NAS.

19. The system of claim 17, wherein the NAS service subsystem is further operative to request the conditional finetuning subsystem for the accuracy check after performing the NAS.

20. The system of claim 17, wherein the NAS service subsystem is further operative to request the conditional finetuning subsystem for the accuracy check before and after performing the NAS.
